(19) United States
(12) Patent Application Publication
(10) Pub. No.: US 2015/0096284 A1
(43) Pub. Date: Apr. 9, 2015

(54) EGR VALVE WITH RING SEAL FOR ZERO FLOW

(71) Applicants: Paul Gottemoller, Palos Park, IL (US); Luis Carlos Cattani, Aurora, IL (US)

(72) Inventors: Paul Gottemoller, Palos Park, IL (US); Luis Carlos Cattani, Aurora, IL (US)

(73) Assignee: International Engine Entellectual Property Company ,LLC, Lisle (FR)

(21) Appl. No.: 14/397,017

(22) PCT Filed: May 3, 2012
(86) PCT No.: PCT/US12/36409

§ 371 Date: Oct. 24, 2014

(51) Int. Cl. F02M 25/07

(52) U.S. Cl. CPC F02M 25/0793; F02M 25/0706; F02M 25/0726
USPC 60/278; 251/306

(57) ABSTRACT

A valve assembly and air flow management assembly for use in an exhaust gas recirculation system capable of providing substantially zero air flow at closure, is described. The valve assembly includes a valve housing having a central axis bore, a rotatable support shaft disposed centrally within the housing, a flapper having an outer circumferential edge, the flapper operably connected to the support shaft and, a ring seal integral with the outer circumferential edge of the flapper, wherein the ring seal closes an opening between the flapper and the bore when the flapper is in the closed position. The outer circumferential edge of the flapper further includes a groove having the ring seal disposed within the groove, wherein the seal floats within the groove, eliminating thermal stress and providing improved sealing capabilities.

### TECHNICAL FIELD

The present assembly and system relates to an exhaust gas recirculation system to control emissions. Particularly, the present disclosure relates to a valve assembly, including an EGR valve assembly that when closed provides a substantially zero level of air flow through the system, permitting an accurate measurement of mass air flow.

### BACKGROUND

Diesel engines are efficient, durable and economical. In the past 20 years, governments, such as the United States and the European Union, have proposed stricter diesel exhaust emission regulations. These environmental regulations require diesel engines to meet increasing stricter pollution emission standards. Typically, to meet such regulations and standards, diesel engine systems require equipment additions and modifications.

For example, a lean burning engine provides improved fuel efficiency by operating with an amount of oxygen in excess of the amount necessary for complete combustion of the fuel. Such engines are said to run “lean” or on a “lean mixture.” However, the increase in fuel efficiency is offset by the creation of undesirable pollution emissions in the form of nitrogen oxides (NOₓ). Nitrogen oxide emissions are regulated through regular emission testing requirements.

Many internal combustion engines use an exhaust gas recirculation (EGR) system to reduce the production of NOₓ during the combustion process in the cylinders. EGR systems typically divert a portion of the exhaust gases exiting the cylinders for mixing with intake air. The exhaust gas generally lowers the combustion temperature of the fuel below the temperature where nitrogen combines with oxygen to form NOₓ. EGR systems have an EGR cooler or heat exchanger that reduces the temperature of the exhaust gases. Generally, more exhaust gas can be mixed with the intake air when the exhaust gas temperature is lower. Additional exhaust gases in the intake air may further reduce the amount of NOₓ produced by the engine. The EGR system includes an EGR valve. The EGR valve directs at least a portion of the gaseous fluid from an exhaust manifold of the engine through an EGR cooler, wherein the gaseous fluid is eventually recirculated into an intake manifold of the engine along with fresh air. The EGR valve is generally controlled by an actuator in order to control the amount of gaseous fluid passing through the EGR valve and being recirculated into the intake manifold.

With modern engines, including diesel engines, which use EGR systems to control emissions, it is important to have the option to close the EGR valve. The EGR valve is placed between the exhaust path and the EGR path, and directs the flow as desired. Closing the EGR valve is used to reduce the cooling system load at altitude, but is also used for calibration of the mass air flow measuring system. With the latest low emission engines, it is necessary to have an accurate measurement of mass air flow through the engine. Thus, to calibrate this system on a running engine, it is necessary to have the ability to completely turn off the EGR flow.

Early attempts to achieve full closure of the EGR valve utilized hard stops within the bore, where the valve plate would contact a physical step or projection in the bore (FIG. 1). However, this design developed issues with high strain on the shaft supporting the valve plate and bore, because the hard stops would not allow for thermal expansion variation between the components. Additionally, the design often resulted in gear wear because the gear train was typically on the same tooth to tooth mesh when it stopped. Therefore, there is a need for an EGR valve assembly offering full closure of the valve, while minimizing any leakage between the closed valve and bore. There is also a need for a valve assembly that when closed, offers a substantially zero air flow for more accurate measurement of mass air flow through the engine. The present valve assembly overcomes the disadvantages of prior systems.

These and other aspects of the present valve and valve assembly may be understood more readily from the following description and the appended drawings.

### SUMMARY

There is disclosed herein a device and assembly, which avoids the disadvantages of prior devices while affording additional operating advantages.

Generally speaking, a valve assembly for use in an exhaust gas recirculation system capable of providing substantially zero air flow at closure and minimizing the closed leak rate, is described and claimed.

In an embodiment, a valve assembly for use in an internal combustion engine exhaust gas recirculation system, is disclosed. The valve assembly comprises a valve housing having a central axis bore, a rotatable support shaft disposed centrally within the housing, a flapper having an outer circumferential edge, the flapper operably connected to the support shaft and, a ring seal integral with the outer circumferential edge of the flapper, wherein the ring seal closes an opening between the flapper and the bore when the flapper is in the closed position.

In another embodiment, the outer circumferential edge of the flapper further includes a groove having the ring seal disposed within the groove.

In another embodiment, the ring seal further includes at least one gap. In yet another embodiment, an end of the shaft aligns with the gap when the flapper is in a closed position further sealing the bore for substantially zero air flow.

In yet another embodiment, an air management assembly, is disclosed. The air management assembly includes an engine having an exhaust side and an opposing intake side, an EGR cooler fluidly connected to the exhaust side, a valve assembly fluidly connected to the EGR cooler comprising, a valve housing having a central axis bore, a rotatable support shaft disposed centrally within the housing, a valve flapper mounted on the support shaft for rotatably opening and closing the bore, the valve flapper including an outer circumferential groove, and, a sealing ring seated within the circumferential groove of the flapper, wherein the sealing ring seals against the bore providing substantially zero air flow when the flapper is in a closed position.

In yet another embodiment of the air management assembly, the sealing ring includes opposing gaps wherein the support shaft aligns with the ring gaps when the valve flapper is rotated into the closed position, sealing the bore and providing substantially zero air flow through the bore.

These and other aspects of the present valve and air management assembly may be understood more readily from the following description and the appended drawings.

### BRIEF DESCRIPTION OF THE DRAWINGS

FIG. 1 is an embodiment of a prior art valve assembly;

FIG. 2 is a schematic diagram of a portion of an internal combustion engine system having a turbocharger and an EGR system including a valve assembly according to the present disclosure;

FIG. 3 is a front view of the valve assembly according to the present disclosure; and,

FIG. 4 is a side view of the valve assembly according to the present disclosure.

### DETAILED DESCRIPTION

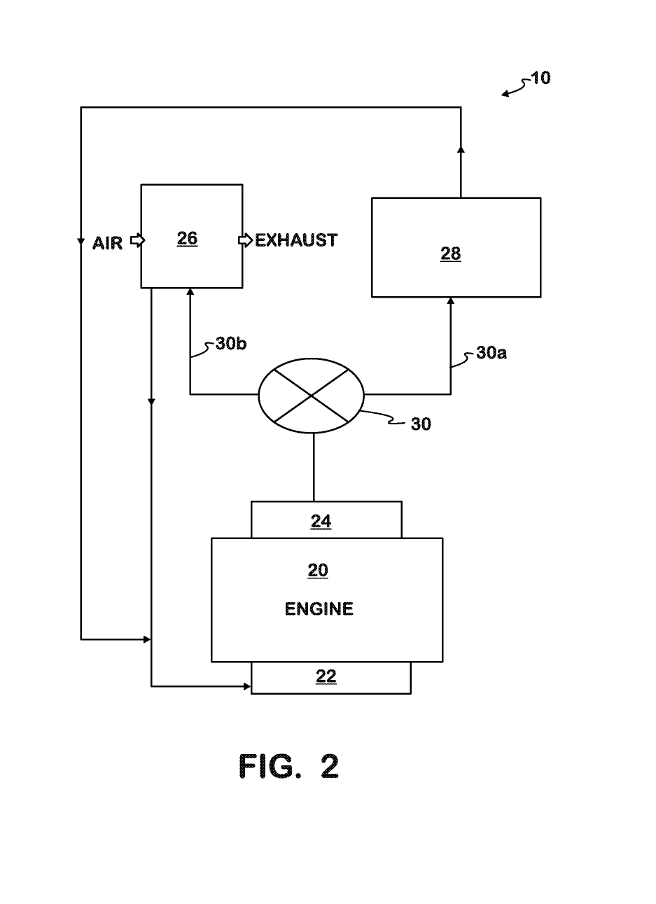

Referring to FIGS. 2-4, there is illustrated an air management assembly, which incorporates valve assemblies including that of the present disclosure. Such valve assemblies are intended to be used with turbocharged or non-turbocharged gasoline and/or diesel powered internal combustion engines, as well as other types of engines. FIG. 2 is a schematic illustration of a portion of conventional turbocharged internal combustion engine system 10 comprising an engine 20 having an intake manifold 22 and an exhaust manifold 24. In the illustrated embodiment, the engine also includes a turbocharger 26, generally comprising a turbine for receiving exhaust gas from the engine exhaust manifold and a compressor for receiving and compressing intake air before being routed for combustion in the engine. These and other features of an engine are generally understood, and will not be described in further detail, except with regard to the specific disclosure.

As shown in FIG. 2, the engine 20 also includes an exhaust gas recirculation (EGR) system, generally designated as 28. The EGR system includes an EGR control valve assembly 30 that is interposed between the turbocharger 26 and the engine 20 and connected together by suitable piping and/or manifolding. The EGR valve assembly 30 operates to receive and regulate the proportion of exhaust gas that is taken from the exhaust manifold and either circulated through the EGR system 28 by the EGR path 30a, or directed to the turbine of the turbocharger 26 by the exhaust path 30b. The EGR valve assembly 30 directs the gaseous fluid through either, both or neither of the EGR path 30a and the exhaust path 30b. For example, to increase the flow through the EGR path 30a, the valve assembly may close completely the exhaust path 30b which increases the back pressure of the gaseous fluid resulting in an increased flow through the EGR path. As mentioned, with the latest low emission engines, it is necessary to have an accurate measurement of mass air flow through the engine. Thus, to calibrate this system on a running engine, it is desirable to have the ability to regulate the flow, including completely turning off the EGR flow.

The type of valve useful in achieving the desired zero flow of EGR gases may vary by application and implementation. Suitable valves include a butterfly or flapper valve, the use and operation of which is known in air management systems. Butterfly or flapper valves and valve assemblies are configured for use in EGR situations calling for an improved degree of flow control sensitivity from an open position to a closed position, or even to a partially closed position. There is a need, as discussed the present disclosure, for controlling the closure of the butterfly valve to provide an improved, substantially leak proof seal. As understood, the butterfly valve is operated by a power source in a rotational direction about a longitudinal axis, opening and closing the EGR path and the exhaust path.

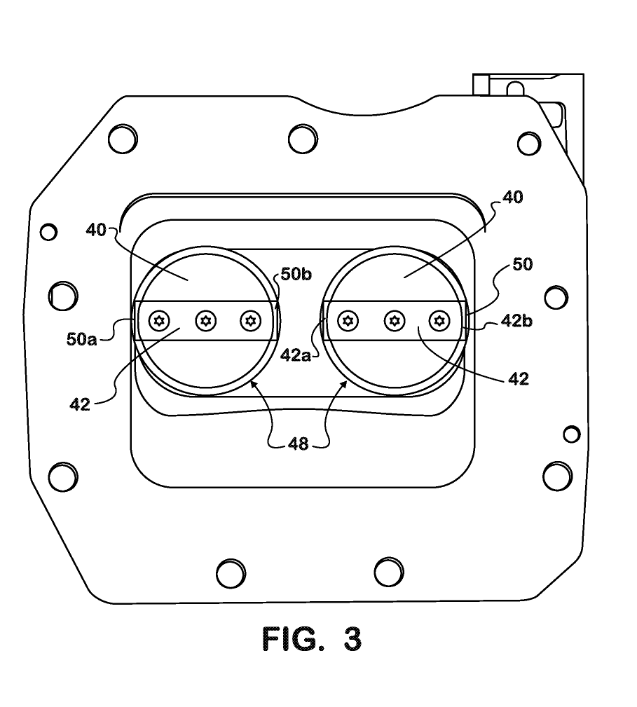

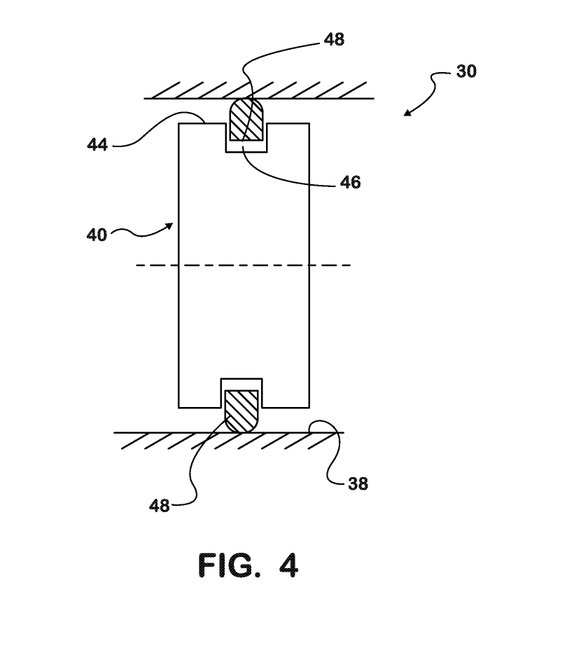

FIGS. 3 and 4 show a front view and a side view respectively, of an embodiment of the valve assembly 30 of the present disclosure. As shown in FIG. 3, the butterfly valve 36 is situated in a valve housing bore 38. The valve 36 includes a generally circular valve flapper 40 extending radially outward from a center support shaft 42, which activates the valve. Activation of the valve can be accomplished by sending a signal to the shaft from an engine control unit (not shown), which determines the desired valve position, and to which pathway the gaseous fluid flows. Sensors (not shown), such as position sensors, pressure sensors, mass air flow sensors or the like may also be incorporated into the system to move the shaft and position the valve.

The valve flapper 40 is circular, semicircular or disc shaped, and is sized and shaped to fit within the housing or bore 38, which also has a generally circular shape. When the valve 36 is placed in a closed position, the flapper 40 is positioned perpendicular to a direction of exhaust gas flow, to close and block off the flow of exhaust gas traveling through the bore 38. When the valve 36 is placed in an open position, the valve flapper 40 is positioned parallel to the direction of flow of exhaust gas traveling through the bore 38.

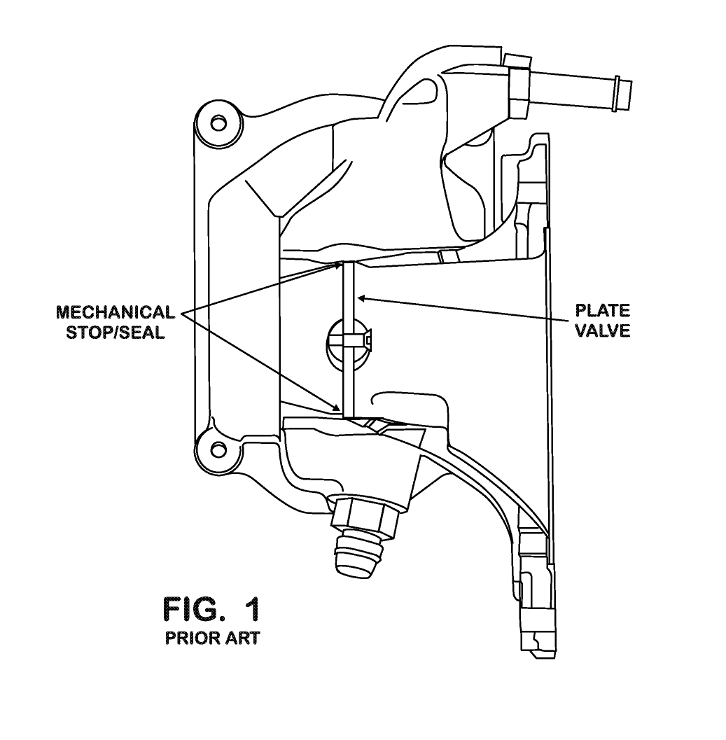

When the valve flapper 40 is in the closed position, it effectively seals against the bore 38. However, in order to improve the sealing feature of the valve assembly 30 to provide a substantially zero air flow and minimize the leak rate, a ring seal 48 is included in the assembly. As shown in FIG. 3, the ring seal 48 is positioned around the outer circumferential edge 44 of the flapper 40. In this manner, the ring seal 48 seals against the rounded bore 38, which avoids the need for the steps, projections or other hard stops used in prior art designs (FIG. 1), which can be difficult to machine accurately. Thus, the present ring seal 48, in addition to the improved sealing features, provides a simpler design for manufacture. By way of reference, the ring seal 48 is designed to perform in a manner similar to that of an engine piston ring.

In another embodiment, the ring seal 48 is more integrated into the outer circumferential edge 44 of the valve flapper 40. For example, FIG. 4 illustrates a side view of the valve assembly, showing a groove 46 incorporated into the outer circumferential edge 44 of the flapper 40. In this embodiment, the ring seal 48 is positioned within the groove 46, such that the seal essentially “floats” within the groove. In this position, the ring seal 48 can move relative to the bore, which eliminates thermal stress on the seal. The ring seal 48 can be constructed from any suitable elastomeric material, which permits the ring seal to seal against the bore with an elastic deformation force.

The ring seal 48 is not a continuous loop; rather, it includes at least one opening or ring gap 50. The position and number of ring gaps 50 may vary depending on the flow requirements of a particular system. For example, in the embodiment shown in FIG. 3, there are two ring gaps 50a, 50b, which are diametrically opposed from one another when the flapper 40 is positioned to close off the air flow, opposing ends of the shaft 42a, 42b align with the ring gaps 50a, 50b, providing closure and minimizing leakage. The ring seal 48 crowns perpendicular to the shaft. This prevents the ring edge from catching the bore. In addition, the ring 48 is pressure activated, wherein the sealing pressure increases as the exhaust pressure increases. Thus, use of the ring seal 48 provides an improved degree of sealing and leak resistance even in high exhaust pressure situations, such as those found in a diesel engine.

In the prior art design of FIG. 1, use of mechanical stops or projections create an area where combustion residue or carbon can accumulate. This accumulation could cause the butterfly valve to stick once closed, and thus not operate properly, which will also affect obtaining an accurate measure of mass air flow through the engine. Additionally, the carbon or combustion debris buildup may result in an incomplete seal between the valve and the bore. Use of the present valve assembly avoids some of these disadvantages. Specifically, use of the ring seal 48 allows the shaft 42 to rotate past the closed position to clean out any carbon and combustion debris to prevent sticking of the valve flapper 40. A cleaning cycle for the carbon residue can be done at key on. Also, because mechanical stops are not used to facilitate closure of the valve, this eliminates the gear train wear common with mechanical stops. Finally, the present valve assembly can easily be incorporated into existing systems, providing a cost-effective option for existing air management systems.

What is claimed is:

1. A valve assembly for use in an internal combustion engine exhaust gas recirculation system, the valve assembly comprising:
a valve housing having a central axis bore;
a rotatable support shaft disposed centrally within the housing;
a flapper having an outer circumferential edge, the flapper operably connected to the support shaft; and,
a ring seal integral with the outer circumferential edge of the flapper, wherein the ring seal closes an opening between the flapper and the bore when the flapper is in the closed position.

2. The valve assembly of claim 1, wherein the shaft rotates the flapper between an open position and a closed position.

3. The valve assembly of claim 1, wherein the flapper further comprises at least two planer portions extending axially from a center of the support shaft.

4. The valve assembly of claim 1, wherein the outer circumferential edge of the flapper further includes a groove.

5. The valve assembly of claim 4, wherein the ring seal is disposed within the groove.

6. The valve assembly of claim 1, wherein the ring seal further includes at least one gap.

7. The valve assembly of claim 6, wherein an end of the shaft aligns with the gap when the flapper is in a closed position further sealing the bore for substantially zero air flow.

8. The valve assembly of claim 1, wherein the ring seal includes two opposing gaps.

9. The valve assembly of claim 8, wherein opposing ends of the shaft align with the two opposing gaps when the flapper is in a fully closed position further sealing the bore for substantially zero air flow.

10. An air flow management assembly comprising:
an engine having an exhaust side and an opposing air intake side;
an EGR cooler fluidly connected to the exhaust side;
a valve assembly fluidly connected to the EGR cooler comprising:
a valve housing having a central axis bore;
a rotatable support shaft disposed centrally within the housing;
a valve flapper mounted on the support shaft for rotatably opening and closing the bore, the valve flapper including an outer circumferential groove; and,
a sealing ring seated within the circumferential groove of the valve flapper, wherein the sealing ring seals against the bore providing substantially zero air flow when the flapper is in a closed position.

11. The air flow management assembly of claim 10, wherein the sealing ring includes opposing gaps.

12. The air flow management assembly of claim 10, wherein the support shaft aligns with the ring gaps when the valve flapper is rotated into the closed position.

13. The air flow management assembly of claim 12, wherein the aligned support shaft further seals the bore providing substantially zero air flow through the bore.

14. The air flow management assembly of claim 10, wherein the sealing ring floats within the circumferential groove.

15. The air flow management assembly of claim 10, wherein the sealing ring is pressure activated for sealing against the bore.
